(19) United States
(12) Patent Application Publication
(10) Pub. No.: US 2016/0189445 A1
(43) Pub. Date: Jun. 30, 2016

(54) SYSTEM FOR MANAGEMENT OF DATA FILES FOR AGRICULTURAL MACHINES

(71) Applicant: AGCO Corporation, Hesston, KS (US)

(72) Inventors: Kyle Kenneth Schmidt, Duluth, GA (US); Timothy Dan Buhler, Newton, KS (US)

(21) Appl. No.: 14/985,001

(22) Filed: Dec. 30, 2015

Related U.S. Application Data
(60) Provisional application No. 62/098,225, filed on Dec. 30, 2014.

(51) Int. Cl. G07C 5/08; A01D 41/127; G05B 15/02; G07C 5/02; G06F 17/30; H04W 4/00

(52) U.S. Cl. CPC G07C 5/085; G06F 17/30221; H04W 4/008; G05B 15/02; G07C 5/02; A01D 41/127

(57) ABSTRACT

An agricultural machine for performing field operations comprises a mechanical component and a control system. The mechanical component performs an operation in a field. The control system controls the functioning of the mechanical component and includes a communication element, a memory element, and a processing element. The communication element communicates wirelessly with external electronic devices. The memory element stores work record files. The processing element records data resulting from the operation of the mechanical component, writes the recorded data to a work record file, transmits to an external electronic device through the communication element the work record file, and deletes the work record file when a confirmation signal is received from the external electronic device.

### RELATED APPLICATION

Under provisions of 35 U.S.C. §119(e), Applicant claims the benefit of U.S. Provisional Application No. 62/098,225, entitled “SYSTEM FOR MANAGEMENT OF DATA FILES FOR AGRICULTURAL MACHINES” and filed Dec. 30, 2014, which is incorporated herein by reference.

### BACKGROUND OF THE INVENTION

1. Field of Invention

Embodiments of the current invention relate to the management of data files that are utilized in agricultural operations.

2. Description of Related Art

Farmers or farm managers often prepare or schedule operations, such as crops to plant or reap, fertilizers or pesticides to apply, or the like, typically for a year for all of the fields in their charge. The operations may include a set of instructions or a program stored in a work order file for a particular agricultural machine to operate in a particular field on a particular day. The farmer may upload a plurality of work order files, perhaps an entire year's worth, to a data storage server. Ideally, an operator for the agricultural machine will download, from the data storage server, the proper work order file to an electronic control system in the machine for the particular field on the particular day. However, due to variability of wireless signal service, resulting from atmospheric or weather issues, gaps in coverage created by terrain, spikes in wireless signal traffic, and the like, it may be difficult for the operator to download any data. In addition, when the operator is able to download data, he may be presented with a list of work order files that have cryptic names and no other information relating to the particular machine, the particular field, or the particular day. Confusion may arise as to which work order file to download because of a lack of descriptive information accompanying the files.

While each operation is in progress, the agricultural machine may record data regarding the results of the operation. After the operation is complete, the recorded data may be written to a work record file that is stored in an onboard memory element. The work record file should then be uploaded to a data storage server and subsequently deleted from the onboard memory element. However, due to the variability of wireless signal service mentioned above, the work record file may not be successfully uploaded. Thus, operators will have to remember to upload the work record file at a later time. Operators may forget to do this. Over time, the work record files may accumulate in the memory elements on each machine from previous operations. To maintain available storage space, the operator may have to manually delete the old files. Operators may inadvertently delete work record files before they have been uploaded.

### SUMMARY OF THE INVENTION

Embodiments of the current invention solve the above-mentioned problems and provide a distinct advance in the art of agricultural operations. More particularly, embodiments of the invention provide agricultural machines for performing field operations and systems that manage data files used in agricultural operations.

An embodiment of the agricultural machine broadly comprises a mechanical component and a control system. The mechanical component performs an operation in a field. The control system controls the functioning of the mechanical component and includes a location determining element, a communication element, a memory element, and a processing element. The location determining element determines a current geolocation of the agricultural machine. The communication element communicates wirelessly with external electronic devices. The memory element stores work record files. The processing element records data resulting from the operation of the mechanical component, writes the recorded data to a work record file, transmits to an external electronic device through the communication element the work record file, and deletes the work record file when a confirmation signal is received from the external electronic device.

An embodiment of the system broadly comprises an agricultural machine and a software application executed by a processing element on a mobile electronic device. The agricultural machine includes a mechanical component that performs an operation in a field and a control system for controlling functioning of the mechanical component. The control system controls the functioning of the mechanical component and includes a location determining element, a communication element, a memory element, and a processing element. The location determining element determines a current geolocation of the agricultural machine. The communication element communicates wirelessly with external electronic devices. The memory element stores work record files. The processing element records data resulting from the operation of the mechanical component, writes the recorded data to a work record file, transmits to an external electronic device through the communication element the work record file, and deletes the work record file when a confirmation signal is received from the external electronic device. The software application instructs the processing element of the mobile electronic device to receive the work record file from the agricultural machine, transmit the work record file to a data storage server, and transmit the confirmation signal to the agricultural machine.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF THE DRAWING FIGURES

Embodiments of the current invention are described in detail below with reference to the attached drawing figures, wherein:

FIG. 1 is a perspective environmental view of a system for managing data files used in the operation of agricultural machines, constructed in accordance with various embodiments of the current invention;

FIG. 2 is a schematic block diagram of various components of a computing device that interfaces with the system;

FIG. 3 is a schematic block diagram of various components of an agricultural machine, which is part of the system of FIG. 1;

FIG. 4 is a schematic block diagram of a mobile electronic device on which a software application is executed, the software application being part of the system of FIG. 1;

FIG. 5 is a screen capture of a display of the mobile electronic device showing some aspects of the software application; and

FIG. 6 is a screen capture of the display of the mobile electronic device showing other aspects of the software application.

The drawing figures do not limit the current invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

In this description, references to one embodiment“, an embodiment”, or “embodiments” mean that the feature or features being referred to are included in at least one embodiment of the technology. Separate references to one embodiment“, an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current technology can include a variety of combinations and/or integrations of the embodiments described herein.

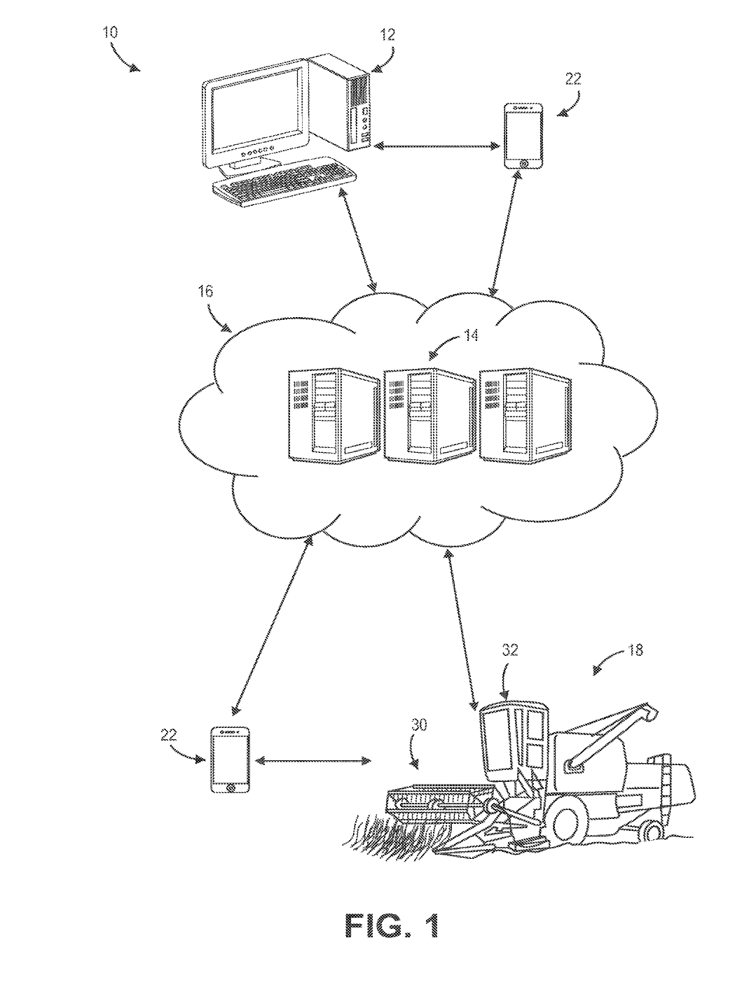

A system 10 for managing data files used in the operation of agricultural machines and constructed in accordance with various embodiments of the current invention is shown in FIG. 1. The system 10 may be utilized to interface with one or more computing devices 12 and one or more data storage servers 14 through a communication network 16. An embodiment of the system 10 broadly comprises an agricultural machine 18 and a software application 20 that is executed on a mobile electronic device 22.

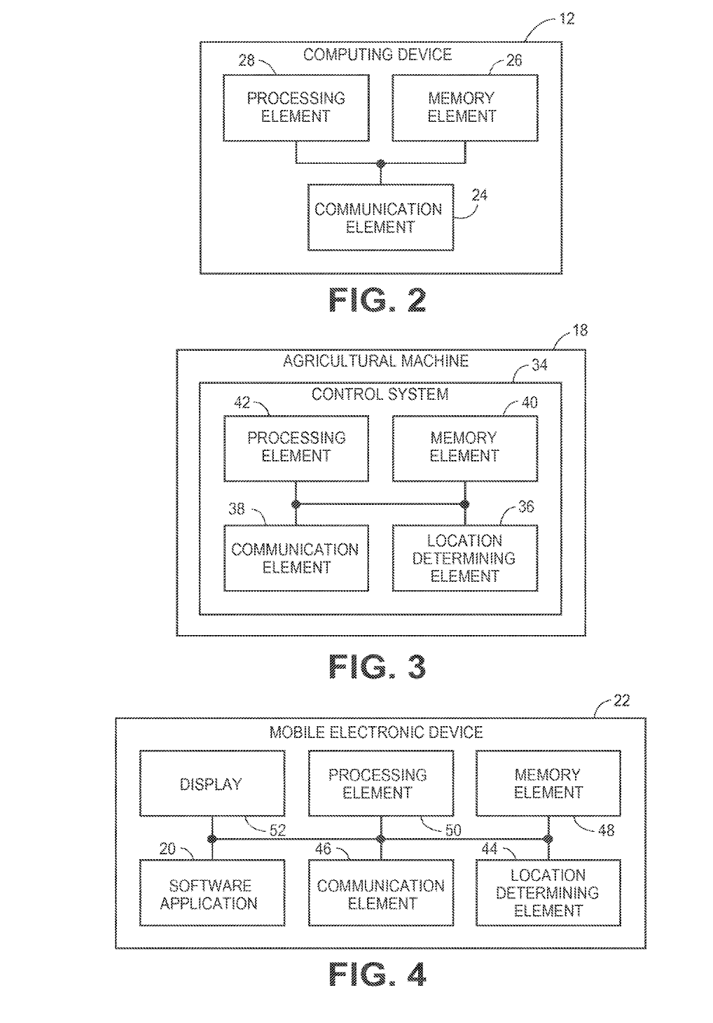

The computing device 12, as seen in FIGS. 1 and 2, is generally utilized by a user, such as a farmer, a farm manager, a farm consultant or contractor, an agronomist, and so forth, to create work order files. The computing device 12 may be embodied by workstation computers, desktop computers, laptop computers, palmtop computers, notebook computers, or the like, and may include at least a communication element 24, a memory element 26, and a processing element 28.

The communication element 24 generally allows communication with external systems or devices. The communication element 24 may include signal or data transmitting and receiving circuits, such as antennas, amplifiers, filters, mixers, oscillators, digital signal processors (DSPs), and the like. The communication element 24 may establish communication wirelessly by utilizing radio frequency (RF) signals and/or data that comply with communication standards such as cellular 2G, 3G, or 4G, Institute of Electrical and Electronics Engineers (IEEE) 802.11 standards such as WiFi, IEEE 802.16 standard such as WiMAX, Bluetooth™, or combinations thereof. Alternatively, or in addition, the communication element 24 may establish communication through connectors or couplers that receive metal conductor wires or cables which are compatible with networking technologies such as ethernet. In certain embodiments, the communication element 24 may also couple with optical fiber cables. The communication element 24 may be in communication with the processing element 28 and the memory element 26.

The memory element 26 may include data storage components such as read-only memory (ROM), programmable ROM, erasable programmable ROM, random-access memory (RAM) such as static RAM (SRAM) or dynamic RAM (DRAM), cache memory, hard disks, floppy disks, optical disks, flash memory, thumb drives, universal serial bus (USB) drives, or the like, or combinations thereof. The memory element 26 may include, or may constitute, a “computer-readable medium”. The memory element 26 may store the instructions, code, code segments, software, firmware, programs, applications, apps, services, daemons, or the like that are executed by the processing element 28. The memory element 26 may also store electronic data, settings, documents, sound files, photographs, movies, images, databases, and the like, as well as work order files.

The processing element 28 may include processors, microprocessors, microcontrollers, digital signal processors (DSPs), field-programmable gate arrays (FPGAs), analog and/or digital application-specific integrated circuits (ASICs), or the like, or combinations thereof. The processing element 28 may generally execute, process, or run instructions, code, code segments, software, firmware, programs, applications, apps, processes, services, daemons, or the like. The processing element 28 may also include hardware components such as finite-state machines, sequential and combinational logic, and other electronic circuits that can perform the functions necessary for the operation of the current invention. The processing element 28 may be in communication with other electronic components through serial or parallel links that include address busses, data busses, control lines, and the like.

The processing element 28 may be configured to execute agricultural-oriented software such as a field management information system (FMIS), which may be utilized to create the work order file. In various embodiments, the computing device 12 executing the FMIS may constitute a geographic information system (GIS). The work order file may include one or more subfiles that contain information regarding the farmer, the consultant, or a customer, as well as resource allocations of products (such as herbicides or pesticides), varieties, machine operator personnel, agricultural machines, and the like. The work order file may further include prescriptions, guidance line usage, and timing information. In addition, the work order file may include geolocation information, such as latitude and longitude or other geographic coordinates, that identify a particular field in which operations may be performed. Typically, one work order file is created for a given operation or task for a particular field and may identify a specific timeframe for the operation, as well as one or more machine operator personnel and a specific agricultural machine 18 or a type of agricultural machine 18. Furthermore, the work order file may be generated or exported utilizing extensible markup language that conforms to the international standardization organization standard 11783-10 or others, known as ISOXML. The work order file may be zipped or compressed so that all of the subfiles are kept together. Each work order file may be generated with a plain nondescript filename.

The computing device 12 may also be configured to receive, with the communication element 24, work record files that are generated by the agricultural machine 18, as described in more detail below. The computing device 12 may allow the user to review the work record files.

The data storage server 14, seen in FIG. 1, generally stores electronic data such as work order files and may include application servers, database servers, file servers, gaming servers, mail servers, print servers, web servers, or the like, or combinations thereof. Furthermore, the data storage server 14 may include a plurality of servers, virtual servers, or combinations thereof. The data storage server 14 may also include one or more communication elements, memory elements, and processing elements, each substantially similar to the like named components discussed above for the computing device 12. The data storage server 14 may store, at the least, work order files and work record files. The data storage server 14 may send the files to and receive the files from the computing device 12, the mobile electronic device 22, and the agricultural machine 18 through the communication network 16.

The communication network 16, seen in FIG. 1, generally allows communication between the computing device 12, the data storage server 14, the agricultural machine 18, and the mobile electronic device 22. The communication network 16 may include local area networks, metro area networks, wide area networks, cloud networks, the Internet, cellular networks, plain old telephone service (POTS) networks, and the like, or combinations thereof. The communication network 16 may be wired, wireless, or combinations thereof and may include components such as switches, routers, hubs, access points, repeaters, towers, and the like. The devices and machines may connect to the communication network 16 either through wires, such as electrical cables or fiber optic cables, or wirelessly, such as RF communication using wireless standards such as cellular 2G, 3G, or 4G, IEEE 802.11 standards such as WiFi, IEEE 802.16 standards such as WiMAX, Bluetooth™, or combinations thereof.

The agricultural machine 18, as seen in FIGS. 1 and 3, may be embodied by farm or agricultural equipment such as wheeled, tracked, or articulating tractors, combine harvesters, forage harvesters, cotton harvesters, windrowers, sprayers, particulate or fertilizer spreaders, or the like. The agricultural machine 18 may be able to perform operations such as plowing, seeding, spraying fertilizer or pesticide, harvesting, and so forth. The agricultural machine 18 may include mechanical components 30 such as rotors, cutter bars, augers, choppers, drums, and the like. In addition, the agricultural machine 18 may include an operator cabin 32 and a control system 34 comprising, at the least, a location determining element 36, a communication element 38, a memory element 40, and a processing element 42. The agricultural machine 18 may further include sensors and the like that measure machine operating parameters as well as results of field operations.

The operator cabin 32 may include space in which an operator can sit while operating the agricultural machine 18 as well as a console with one or more video displays and user interface components, such as joysticks, keypads, keyboards, or combinations thereof.

The location determining element 36 generally determines a current geolocation of the agricultural machine 18 and may receive and process radio frequency (RF) signals from a global navigation satellite system (GNSS) such as the global positioning system (GPS) primarily used in the United States, the GLONASS system primarily used in the Soviet Union, or the Galileo system primarily used in Europe. The location determining element 36 may accompany or include an antenna to assist in receiving the satellite signals. The antenna may be a patch antenna, a linear antenna, or any other type of antenna that can be used with location or navigation devices. The location determining element 36 may include satellite navigation receivers, processors, controllers, other computing devices, or combinations thereof, and memory. The location determining element 36 may process a signal, referred to herein as a “location signal”, from one or more satellites that includes data from which geographic information such as the current geolocation is derived. The current geolocation may include coordinates, such as the latitude and longitude, of the current location of the agricultural machine 18. The location determining element 36 may communicate the current geolocation to the processing element 42, the memory element 40, or both.

Although embodiments of the location determining element 36 may include a satellite navigation receiver, it will be appreciated that other location-determining technology may be used. For example, cellular towers or any customized transmitting radio frequency towers can be used instead of satellites may be used to determine the location of the agricultural machine 18 by receiving data from at least three transmitting locations and then performing basic triangulation calculations to determine the relative position of the device with respect to the transmitting locations. With such a configuration, any standard geometric triangulation algorithm can be used to determine the location of the electronic device. The location determining element 36 may also include or be coupled with a pedometer, accelerometer, compass, or other dead-reckoning components which allow it to determine the location of the agricultural machine 18. The location determining element 36 may determine the current geographic location through a communications network, such as by using Assisted GPS (A-GPS), or from another electronic device. The location determining element 36 may even receive location data directly from a user.

The communication element 38, the memory element 40, and the processing element 42 may be substantially similar to the like-named components discussed above for the computing device 12 with the memory element 40 being able to store both work order files and work record files.

The processing element 42 may be configured to both send data to and receive data from external devices and systems through the communication element 38. The processing element 42 may also receive the current geolocation of the agricultural machine 18 from the location determining element 36. In addition, the processing element 42 may include or may constitute a mobile implement control system (MICS). The MICS may control the guidance of the agricultural machine 18 and may control the operation of the mechanical components 30. The control of the guidance and operation of the agricultural machine 18 may be determined in part by the work order file created by the user perhaps utilizing the FMIS on the computing device 12. The work order file may include data, commands, and instructions that are specific to a particular agricultural machine 18, or type thereof, for operations in a particular field during a particular timeframe. Thus, the work order file may include geolocation information that relates to, indicates, or identifies at least a portion of the field as well as an agricultural machine identification and time or date information. The work order file may be received through the communication element 38 and may be executed by the processing element 42 or the MICS. In various embodiments, the processing element 42 may be able to access a plurality of work order files on an external electronic device, such as the data storage server 14 or the mobile electronic device 22. The processing element 42 may be able to receive at least a portion of the data that includes geolocation information from each work order file. The processing element 42 may compare the current geolocation, from the location determining element 36, to the geolocation information of each work order file and may retrieve only those work order files from the external device whose geolocation information is approximately the same as or associated with the current geolocation of the agricultural machine 18. In some embodiments, the processing element 42 may calculate a distance between the current geolocation and the field indicated by the geolocation information included in each work order file. The processing element 42 may retrieve the work order file whose field indicated by geolocation information is the shortest distance from the current geolocation.

In various embodiments, the processing element 42 may also receive agricultural machine and timeframe data from each work order file. The processing element 42 may be further configured to determine the current date and the current time of day. The processing element 42 may then retrieve only those work order files from the external device whose agricultural machine information matches the agricultural machine 18 and whose timeframe information matches the current date.

Furthermore, the processing element 42 may record data from sensors and the like regarding the operations of the agricultural machine 18 as well as results from field operations including quantities such as amounts of seed planted, amounts of products applied to the crops, amounts of crop harvested, etc. The processing element 42 may write the recorded data and results in the work record file which is stored in the memory element 40.

After the field operation has completed and all of the recorded data and results are stored in the work record file, the processing element 42 may receive a request from the user via the mobile electronic device 22 to upload the work record file to the data storage server 14. If the processing element 42, via the communication element 38, can contact the data storage server 14 through the communication network 16, then it will. The processing element 42 may transmit the work record file to the data storage server 14 and may receive confirmation of receipt therefrom. At that point, the processing element 42 may instruct the memory element 40 to delete the work record file. If the processing element 42 cannot contact the data storage server 14 through the communication network 16, then the processing element 42 may transmit the work record file, using Bluetooth™ or other short range wireless communication standards, to the mobile electronic device 22 to be retained. The mobile electronic device 22 may upload the work record to the data storage server 14, perhaps as the user moves around to a location where the mobile electronic device 22 is within signal range of the communication network 16. The mobile electronic device 22 may then transmit to the processing element 42 of the agricultural machine 18 a confirmation that the work record file was successfully uploaded. At that point, the processing element 42 may instruct the memory element 40 to delete the work record file. In some embodiments, the processing element 42 may transmit the work record file to more than one mobile electronic device 22 as a redundancy measure in case any one or more of the mobile electronic devices 22 becomes incapable of uploading the work record file to the data storage server 14. After any one of the mobile electronic devices 22 uploads the work record file, the mobile electronic device 22 sends the confirmation to the processing element 42 which instructs the memory element 40 to delete the work record file. If the processing element 42 receives subsequent confirmation notices from other mobile electronic devices 22, the notices are ignored.

The mobile electronic device 22, as seen in FIGS. 1 and 4, which executes the software application 20 may be embodied by tablets or tablet computers, smartphones, mobile phones, cellular phones, personal digital assistants (PDAs), or the like. The mobile electronic device 22 may include a location determining element 44, a communication element 46, a memory element 48, and a processing element 50, all of which may be substantially similar to the like-named components discussed above for the agricultural machine 18. The memory element 48 may store at least the software application 20, and the processing element 50 may execute at least the software application 20. In addition, the mobile electronic device 22 may include a display 52 among other components.

The software application 20 may be executed on the mobile electronic device 22 and may interact with software executing on the agricultural machine 18, the computing device 12, and the data storage server 14. The software application 20 may include code, commands, and instructions that configure the processing element 50 of the mobile electronic device 22 to perform at least the following functions.

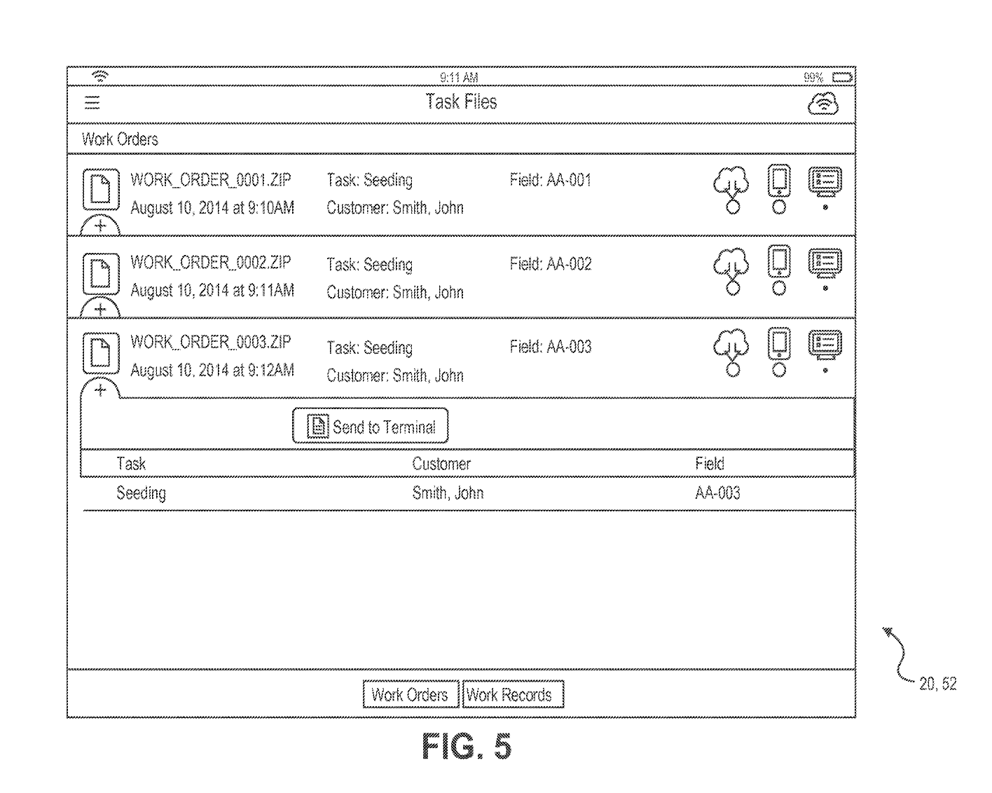

The processing element 50 may utilize the communication element 46 to communicate with the computing device 12 to receive work order files, which may be stored in the memory element 48. The work order files may include descriptional metadata that would help identify the particular operation that is to be performed. Examples of categories of the metadata include a type of operation to be performed, such as seeding, plowing, spraying, etc., a name of the field in which operations are to be performed, a name or type of the agricultural machine 18 that is to be used, a name of a product, such as a particular seed, a pesticide, a fertilizer, etc., that is to be used, a name of the operator of the agricultural machine 18, and the like. The processing element 50 may parse, read, or scan the work order files and may retrieve and record, in the memory element 48, the metadata for each file. The processing element 50 may communicate the metadata and the work order file names to the display 52 of the mobile electronic device 22 to be shown to a user. As shown in the display 52 screen capture in the exemplary embodiment of FIG. 5, the displayed information may include a plurality of rows and columns of data in a table. Each row may include a first column with an original work order file name, which was generated by the FMIS on the computing device 12. Each row may also include one or more columns with labels for the categories of metadata followed by the values of the metadata. In the exemplary embodiment, there may be category labels of “Task”, “Customer”, and “Field”, with a value for each one. Each row may further include columns with icons for downloading or transferring each work order file to other devices, such as other mobile electronic devices 22, the data storage server 14, or the agricultural machine 18. In some embodiments, the user may be allowed to choose which categories of metadata he would like to see displayed. In addition, the software application 20 may provide an icon, generally indicated by a plus (+) sign, that allows the user to view more metadata or information regarding a particular work order file. When the icon is selected, the software application 20 may provide the same metadata as or additional metadata to the metadata that is shown in the other metadata areas. Furthermore, the software application 20 may provide on screen buttons or indicators which the user can press or otherwise select to choose to display either work order files or work record files.

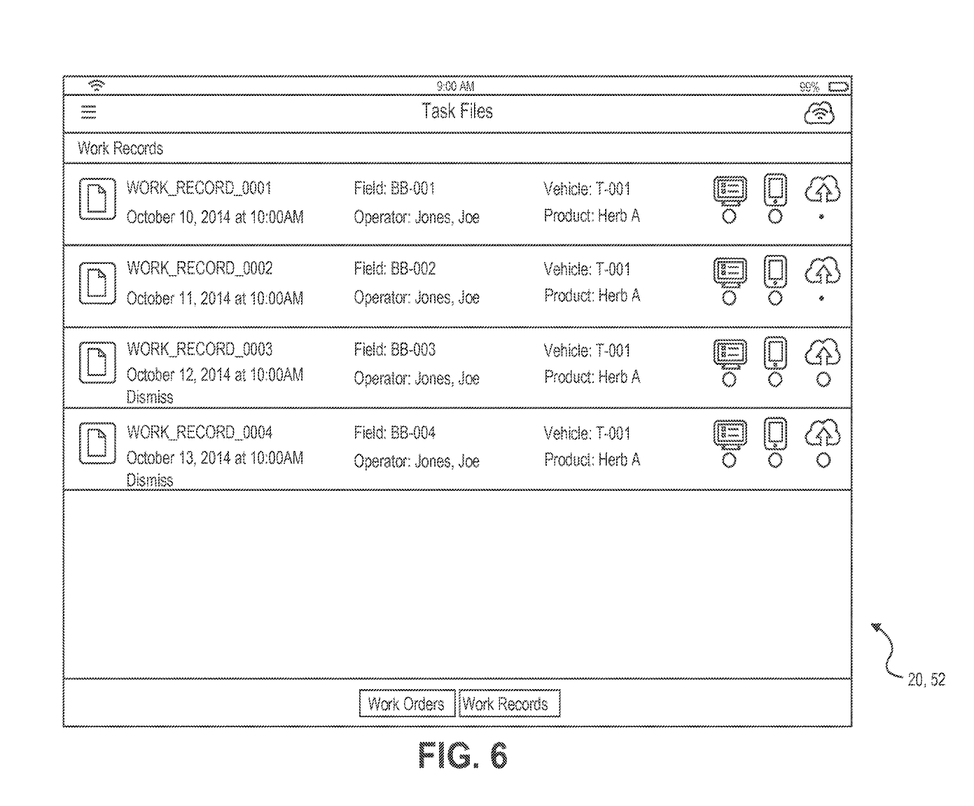

The processing element 50 may utilize the communication element 46 to communicate with one or more agricultural machines 18 to receive work record files, which may be stored in the memory element 48. The processing element 50 may parse, read, or scan the work order files and may retrieve and record, in the memory element 48, the metadata for each file. The processing element 50 may communicate the metadata and the work record file names to the display 52 of the mobile electronic device 22 to be shown to a user in a similar fashion as the work order file names discussed above. As shown in the display 52 screen capture in the exemplary embodiment of FIG. 6, each row may include a first column with an original work record file name, which was generated by the MICS or the processing element 42 on the agricultural machine 18. Each row may also include one or more columns with labels for the categories of metadata followed by the values of the metadata. In the exemplary embodiment, there may be category labels of “Field name”, “Vehicle name”, “Operator name”, and “Product name”, with a value for each one. Each row may further include columns with icons for uploading or transferring each work order file to other devices, such as other mobile electronic devices 22, the data storage server 14, or the agricultural machine 18.

In addition to generating metadata about work record files received from the agricultural machine 18, the processing element 50 may automatically upload the work record files to the data storage server 14. When the processing element 50 has successfully uploaded the files, it may transmit a confirmation notice to the agricultural machine 18, which may delete the work record file from its own memory element 40.

The processing element 50 may receive the current geolocation of the mobile electronic device 22 from the location determining element 44. The memory element 48 may have previously stored or retained work order files that are associated with a plurality of fields, operators, and agricultural machines 18. Each work order file may include geolocation information that relates to, indicates, or identifies at least a portion of a field, or other land area in which agricultural operations are to be performed. In a similar fashion to the processing element 42 of the agricultural machine 18 discussed above, the processing element 50 may compare the current geolocation to the geolocation information of each work order file and may determine the work order file whose geolocation information is approximately the same as or associated with the current geolocation of the mobile electronic device 22. The processing element 50 may also calculate a distance between the current geolocation and the field indicated by the geolocation information included in each work order file and may then select the work order file whose field indicated by geolocation information is the shortest distance from the current geolocation. The processing element 50 may automatically transmit the proper work order file through the communication element 46 to the agricultural machine 18.

Alternatively, the processing element 50 may communicate to the display 52 the name of the work order file that includes geolocation information associated with the current geolocation of the mobile electronic device 22. The user may then select the work order file on the display 52 and may initiate the transfer of the work order file to the agricultural machine 18.

The system 10 may function as follows. The user may create a plurality of work order files utilizing the FMIS software on the computing device 12. Typically, the user creates work order files for an entire year's worth of operations to be performed in one or more fields. Each work order file may include information regarding the farmer, the consultant, or the customer, products, varieties, machine operator personnel, agricultural machines, prescriptions, guidance line usage, timing information, geolocation information, and the like. Once the work order files are created, the user may upload them from the computing device 12 to the data storage server 14, the mobile electronic device 22, or both. In some situations, the user may upload the work order files to the data storage server 14 first and then download them to the mobile electronic device 22, or vice versa.

The processing element 50 in the mobile electronic device 22 that is executing the software application 20 may parse the work order files and retrieve metadata for each work order file. The processing element 50 may then communicate the file list and the metadata to the display 52, as seen in FIG. 5. Thus, the user can see relevant descriptive information about each work order file, such as the task or operation to be done, the customer for whom the task is to be done, the field in which an operation is to be performed, and so forth.

When it is time to perform a particular operation in a particular field, the system 10 provides a plurality of ways in which the proper work order file can be downloaded to the agricultural machine 18 that will perform the field operation.

First, the operator of the agricultural machine 18 or an operations manager may view a list of work order files that are stored in the memory element 48 of the mobile electronic device 22. By utilizing the descriptive metadata that is shown with each file, the operator may select the appropriate work order file for the particular agricultural machine 18 and the particular field. The operator may then download the selected work order file from the mobile electronic device 22 to the agricultural machine 18. The transfer of the work order file may be performed using any transmission protocol but Bluetooth™ or other short range wireless communication standards may be most appropriate.

Second, when the operator is within a short distance of the field in which the operation will be performed with his mobile electronic device 22, the processing element 50 of the mobile electronic device 22 may receive the current geolocation thereof from the location determining element 44. The processing element 50 may select the work order file with geolocation information that is approximately the same as, associated with, or the shortest distance from the current geolocation. The processing element 50 may then transmit, through the communication element 46, the work order file to the agricultural machine 18. Alternatively, the display 52 of the mobile electronic device 22 may show or highlight the name of the work order file with geolocation information that is approximately the same as, associated with, or the shortest distance from the current geolocation. The user may then select the work order file on the display 52 and may initiate the transfer of the work order file to the agricultural machine 18.

Third, when the agricultural machine 18 is within a short distance of the field in which the operation will be performed, the processing element 42 of the agricultural machine 18 may access a plurality of work order files on either the data storage server 14 or the mobile electronic device 22. The processing element 42 may receive at least a portion of the data that includes geolocation information from each work order file. The processing element 42 may compare the current geolocation, from the location determining element 36, to the geolocation information that identifies the field of each work order file and may retrieve only those work order files from the external device whose field-identifying geolocation information is approximately the same as, associated with, or the shortest distance from the current geolocation of the agricultural machine 18.

While field operations are ongoing, the processing element 42 of the agricultural machine 18 may record data and operational results in the work record file, which is stored in the memory element 40. When the operation is complete, the processing element 42 may attempt to upload the work record file to the data storage server 14. If the processing element 42 can establish communication with the data storage server 14, it will upload the work record file and then delete the file from the memory element 40. If the agricultural machine 18 is out of signal range of the communication network 16 and the processing element 42 cannot establish communication with the data storage server 14, then the processing element 42 may transmit the work order file to the mobile electronic device 22, which will store the file in the memory element 48. The operator may be able to view a list of the work record files, along with extracted metadata, that have been delivered to his mobile electronic device 22, as seen in FIG. 6. As the operator possessing the mobile electronic device 22 moves to within signal range of the communication network 16, the processing element 50 may upload the work order file to the data storage server 14. Afterward, when the mobile electronic device 22 is in proximity to the agricultural machine 18, the processing element 50 may transmit a confirmation notice to the processing element 42 of the agricultural machine 18 that the file upload was successful. The processing element 42 may then delete the work order file from the memory element 40.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. An agricultural machine for performing field operations, the agricultural machine comprising:
a mechanical component configured to perform an operation in a field; and
a control system for controlling functioning of the mechanical component, the control system comprising—
a communication element configured to communicate wirelessly with external electronic devices,
a memory element configured to store field work record files, and
a processing element electronically coupled with the memory element and configured to—
record data resulting from the operation of the mechanical component,
write the recorded data to a work record file,
store the work record file in the memory element,
transmit to an external electronic device through the communication element the work record file, and
delete the work record file from the memory element when a confirmation signal is received from the external electronic device.

2. The agricultural machine of claim 1, wherein the mechanical component includes rotors.

3. The agricultural machine of claim 1, wherein the mechanical component includes cutter bars.

4. The agricultural machine of claim 1, wherein the mechanical component includes augers.

5. The agricultural machine of claim 1, wherein the mechanical component includes choppers.

6. The agricultural machine of claim 1, wherein the functioning of the mechanical component includes seeding.

7. The agricultural machine of claim 1, wherein the functioning of the mechanical component includes reaping.

8. The agricultural machine of claim 1, wherein the functioning of the mechanical component includes spraying pesticide.

9. The agricultural machine of claim 1, wherein the functioning of the mechanical component includes spraying herbicide.

10. A system for managing data files used in the operation of agricultural machines, the system comprising:
an agricultural machine comprising—
a mechanical component configured to perform an operation in a field; and
a control system for controlling functioning of the mechanical component, the control system comprising—
a communication element configured to communicate wirelessly with external electronic devices,
a memory element configured to store field work record files, and
a processing element electronically coupled with the memory element and configured to—
record data resulting from the operation of the mechanical component,
write the recorded data to a work record file,
store the work record file in the memory element,
transmit to a mobile electronic device through the communication element the work record file, and
delete the work record file from the memory element when a confirmation signal is received from the external electronic device; and
a software application configured to be executed by a processing element on the mobile electronic device, wherein the software application instructs the processing element to—
receive the work record file from the agricultural machine,
transmit the work record file to a data storage server, and
transmit the confirmation signal to the agricultural machine.

11. The system of claim 10, wherein the mechanical component includes rotors.

12. The system of claim 10, wherein the mechanical component includes cutter bars.

13. The system of claim 10, wherein the mechanical component includes augers.

14. The system of claim 10, wherein the mechanical component includes choppers.

15. The system of claim 10, wherein the functioning of the mechanical component includes seeding.

16. The system of claim 10, wherein the functioning of the mechanical component includes reaping.

17. The system of claim 10, wherein the functioning of the mechanical component includes spraying pesticide.

18. The system of claim 10, wherein the functioning of the mechanical component includes spraying herbicide.

19. A system for managing data files used in the operation of agricultural machines, the system comprising:
an agricultural machine comprising—
a mechanical component configured to perform an operation in a field; and
a control system for controlling functioning of the mechanical component, the control system comprising—
a communication element configured to communicate wirelessly with external electronic devices,
a memory element configured to store field work record files, and
a processing element electronically coupled with the memory element and configured to—
record data resulting from the operation of the mechanical component,
write the recorded data to a work record file,
store the work record file in the memory element,
transmit to a mobile electronic device through the communication element the work record file, and
delete the work record file from the memory element when a confirmation signal is received from the external electronic device; and
a software application configured to be executed by a processing element on the mobile electronic device, wherein the software application instructs the processing element to—
receive the work record file from the agricultural machine,
store the work record file in a memory element of the mobile electronic device,
communicate the work record file to a display of the mobile electronic device,
transmit the work record file to a data storage server, and
transmit the confirmation signal to the agricultural machine.
